(19) United States
(12) Patent Application Publication
(10) Pub. No.: US 2005/0040691 A1
(43) Pub. Date: Feb. 24, 2005

(54) Dual transfer dump trailer set

(76) Inventor: Donald R. Jones, Kingman, AZ (US)

Correspondence Address: PEDERSEN & COMPANY, PLLC, P.O. BOX 2666, BOISE, ID, 83701, US

(21) Appl. No.: 10/865,501

(22) Filed: Jun. 9, 2004

Related U.S. Application Data
(60) Provisional application No. 60/477,451, filed on Jun. 9, 2003.

(51) Int. Cl. B60P 7/00

(52) U.S. Cl. 298/8 T

(57) ABSTRACT

A first and second dumping trailer set adapted to be pulled by a conventional truck or tractor giving truck drivers the flexibility to haul loads of bulk materials without committing to a standard dump truck. The trailer set comprises a first trailer with means for dumping its contents and a second tow vehicle which may be drawn into the first trailer and dumped therein leveraging the dumping structure and mechanisms of the first trailer. Preferably, the trailer set is jack-knifed for dumping such that loads from the first trailer are deposited generally to the side of the tow vehicle path. A winch or other driving mechanism may be used to draw the mobile dumping body of the tow vehicle into the bed of the first trailer after the tongue has been retracted to substantially close the gap between trailer and tow.

This application claims priority of Provisional Application Ser. No. 60/477,451, filed Jun. 9, 2003, entitled “Dual Transfer Dump Trailer Set”, incorporated herein by reference.

### BACKGROUND OF THE INVENTION

1. Field of the Invention

This invention relates generally to hauling loads with tractors and semi-trailers. More specifically, this invention relates to a dump trailer setup that allows such trailers to be hauled in tandem.

2. Related Art

The need to transport loads from one location to another is well established. The need to conveniently unload various materials quickly and easily upon arriving at a particular destination is also well established. As a result, a number of dump trucks and dumping trailers have been developed to haul loads of sand, gravel, solid wastes, and other substances.

U.S. Pat. No. 3,120,408 (Pruss) discloses a dumping tow vehicle for use in combination with a dump truck or dumping trailer. The dumping tow vehicle includes a pair of auxiliary ground-engaging wheels that substantially elevate the tow vehicle above a traveling height to allow the tow vehicle to clear a load dumped immediately behind the dump truck or dumping trailer and in front of the tow vehicle.

Several dumping trailers are known such as, for example those disclosed in U.S. Pat. No. 4,943,118 (Davis) and U.S. Pat. No. 5,184,872 (Larochelle et al.). Each of these patents teaches a dumping body mounted upon a mobile frame which may be drawn by a tow vehicle. In U.S. Pat. No. 4,943,118 the dumping body may be moved between a forward traveling position and a rear dumping position to facilitate simple transport and emptying of the dumping body. In U.S. Pat. No. 5,184,872 a long dumping body with extra carrying capacity is supported by an additional central axle to meet the appropriate safe-transport requirements.

U.S. Pat. No. 6,257,669 (Hicks) teaches a dual trailer assembly including a trailer and tow vehicle wherein a moveable pedestal base alternates between a forward and rear position for transport and dumping the tow vehicle, respectively. The tow vehicle must be detached prior to dumping the trailer to prevent obstacles from being deposited in the path of the tow vehicle.

U.S. Pat. No. 6,283,554 (Oberg) describes a dump truck system including a tow vehicle. To dump the tow vehicle, a dumping body mounted on top of the tow vehicle frame may be pulled into the dump truck bed and tilted until the dumping body is emptied or a separate dumping mechanism may be built into the tow vehicle frame.

Still, there is a need for a simple and effective dual trailer configuration including a first dumping trailer and a tow vehicle which may be dumped wherein the tow vehicle leverages the dumping capabilities of the first trailer to empty its load.

### SUMMARY OF THE INVENTION

The present invention is a versatile dual transfer trailer setup comprising a first dumping semi-trailer and a trailing tow vehicle which may also be dumped. The first trailer may be drawn by any tractor meeting the conditions for safe transport. This way, drivers may haul loads of, for example, sand, gravel or other solid bulk materials without committing to the purchase of specifically a dump truck. The trailer set further allows drivers to properly adjust hauling capacity to meet changing needs (i.e. large vs. small loads) by simply attaching or detaching the tow vehicle from the set. In addition, the trailer set may offer a significant financial advantage to owners/drivers by alleviating some of the expense inherent in securing insurance coverage for dump trucks.

The first trailer and tow vehicle comprise separate base frames with a plurality of ground engaging wheels and an upper dumping body mounted atop the frame. The trailer and tow are pivotally connected via a heavy tongue or other means. The first trailer preferably includes a mechanism, such as, for example, a hydraulic cylinder, for tilting the dumping body so that the contents of the dumping body are emptied to the rear of the trailer. The tow vehicle may be detached prior to dumping the first trailer to prevent the contents of the dumping body from being deposited in the path of the tow. However, to empty the first trailer, the tow and trailer are preferably jack-knifed so that the first trailer may be emptied generally to the side of the tow path. Preferably, the dumping body of the tow vehicle is mounted atop its base frame upon a sliding or otherwise mobile platform. After emptying the first trailer, the first trailer and tow vehicle may be realigned and drawn together via a retracting tongue or other mechanism. The dumping body of the tow may then be hauled into the dumping bed of the first trailer and tilted to empty its contents. After dumping the tow vehicle, the mobile dumping body may be returned to a normal traveling position above the tow frame for transport and subsequent reloading.

### BRIEF DESCRIPTION OF THE DRAWINGS

FIG. 1 is a side elevation view of a prior art dedicated dump truck and dumping trailer combination.

FIG. 2 is a side view of a tractor, semi-trailer and tow vehicle combination according to an embodiment of the invented dual transfer dump trailer set.

FIGS. 3-5 are side, detail views of the individual components of the trailer set of FIG. 1 illustrating the versatility of the component set.

FIG. 6 is an elevation view of the dump trailer set with trailer and tow vehicle jack-knifed and the trailer in the raised position for dumping.

FIG. 7 is a side view of the trailer set of FIG. 1 showing the dumping body of the tow vehicle being drawn into the dumping body of the trailer.

FIG. 8 is an elevation view of the trailer set of FIG. 6 with trailers jack-knifed and the dumping body of the tow in raised position within the dumping body of the trailer.

FIG. 9 is an elevation view of the tow of FIG. 1 with the mobile dumping body removed.

FIG. 10 is an elevation view of the trailer of FIG. 1 with dumping body in raised position and containing the mobile dumping body of the tow for dumping.

### DETAILED DESCRIPTION OF THE INVENTION

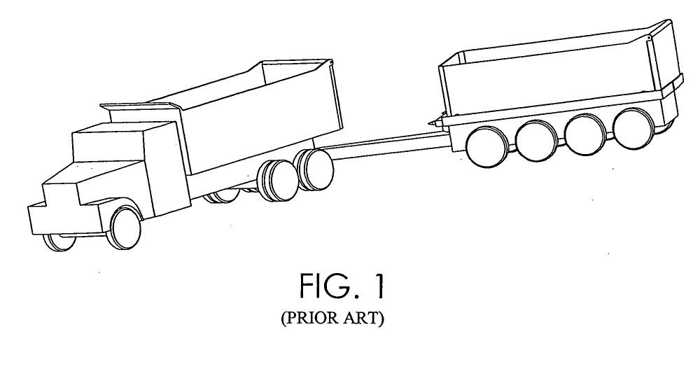

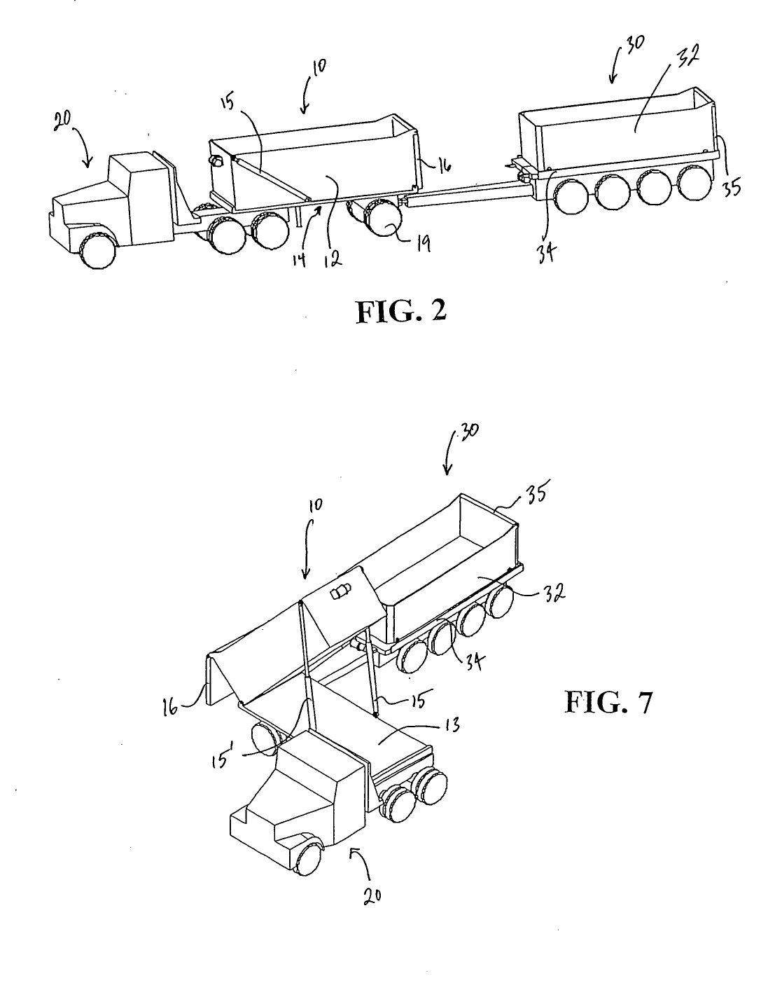

Referring now to the figures, one, but not the only, embodiment of the invented dual transfer dump trailer set is presented along with an example of a prior art bulk hauling vehicle arrangement. For many truck drivers, year-round operation is important, or necessary, to maintain financial viability. For these drivers the hauling of bulk loads presents a considerable challenge. Hauling bulk materials requires specialized equipment that is ill-suited to year-round operations and cannot be easily converted to haul refrigerated, liquid, or other cargos. The dedicated dump truck of FIG. 1 shows one example of such equipment. In regions where harsh weather and/or other factors seasonally afflict construction-related industries, demand for specialized bulk hauling equipment is, at times, very low. Purchasing additional vehicles, designed to haul specific loads, and insuring these vehicles is very expensive. In addition, maintaining and insuring an idle vehicle is very costly. Consequently, a more versatile truck and trailer combination is needed to facilitate year-round operation wherein the hauling of bulk materials is possible when demand is high. The versatile truck and trailer set of the present invention preferably comprises a first dumping trailer 10 configured to be pulled by a conventional tractor 20 and a tow vehicle 30 attached to the rear of the first trailer, as shown in FIG. 2. The tow vehicle 30 may be dumped by drawing the dumping body 32 into the first trailer 10 and tilting the dumping bed 12 of the first trailer. This way, a simple tow vehicle may be produced without additional mechanisms for dumping loads or for clearing loads left in its path by the first trailer. The versatile trailer set allows tractor drivers to haul and dump large loads of sand, gravel or other solid bulk materials without restricting themselves to a dedicated dump truck, such as the one shown in FIG. 1.

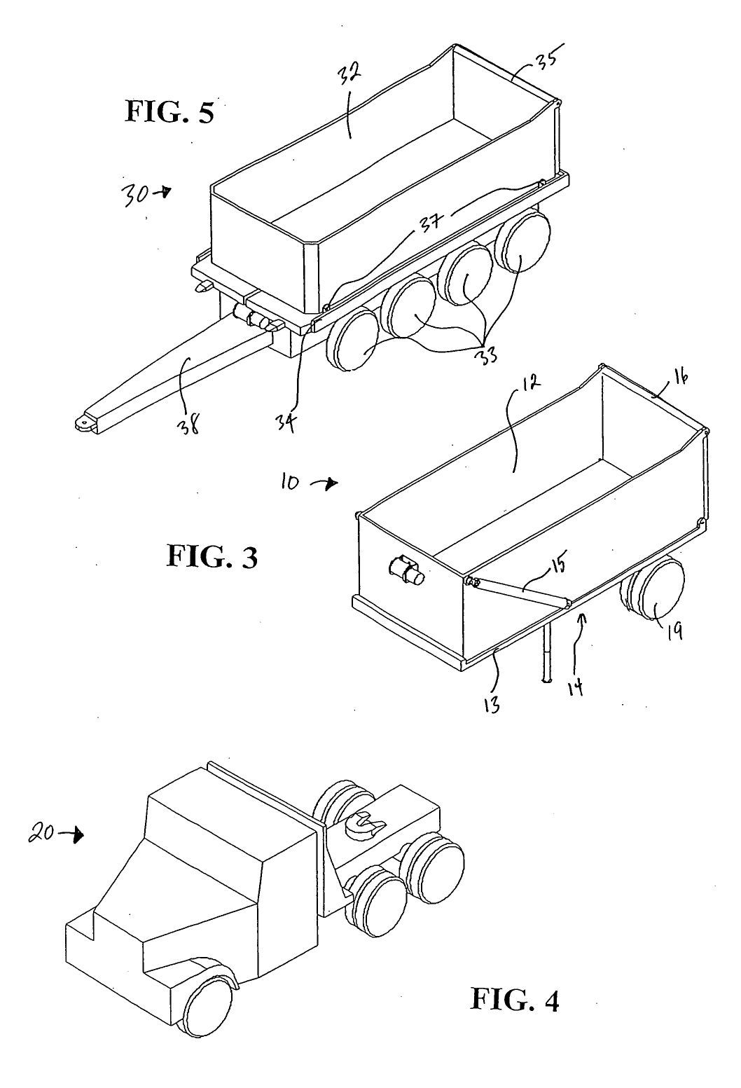

The first trailer 10 comprises a dumping bed 12 mounted atop a supporting frame 14, as shown in FIG. 3, which may be readily connected to the fifth wheel of a conventional truck or tractor, such as the one shown in FIG. 4. In the preferred embodiment, the dumping bed 12 is generally the same length as the supporting frame 14 to maximize the loading capacity. The height and width of the bed may be calculated according to conventional methods for maximum capacity to the extent that the side-to-side stability of the trailer is not compromised. At its rear, the dumping bed includes a gate 16 which may be latched closed for transport and unlatched for emptying loads. Any of a number of conventional latching mechanisms may be used so long as the requirements for safety, security and simplicity are satisfied.

Preferably, the supporting frame consists of a longitudinally extending platform 13 to which are mounted a plurality of ground engaging wheels 19 and suitable means for elevating the dumping bed to a dumping position. Alternatively, a pair of longitudinally extending rails may be substituted for the platform 13 in the supporting frame 14 structure of the first trailer 10. In the preferred embodiment, the mechanism for elevating the dumping bed into a dumping position comprises hydraulic rams 15 & 15′ which may be extended and retracted beneath the dumping bed. Several other alternative frame designs may be foreseen by one skilled in the art and may be implemented so long as the weight of the dumping bed can be supported atop the frame, the frame may be attached to a truck or tractor of conventional design and the dumping bed may be dumped.

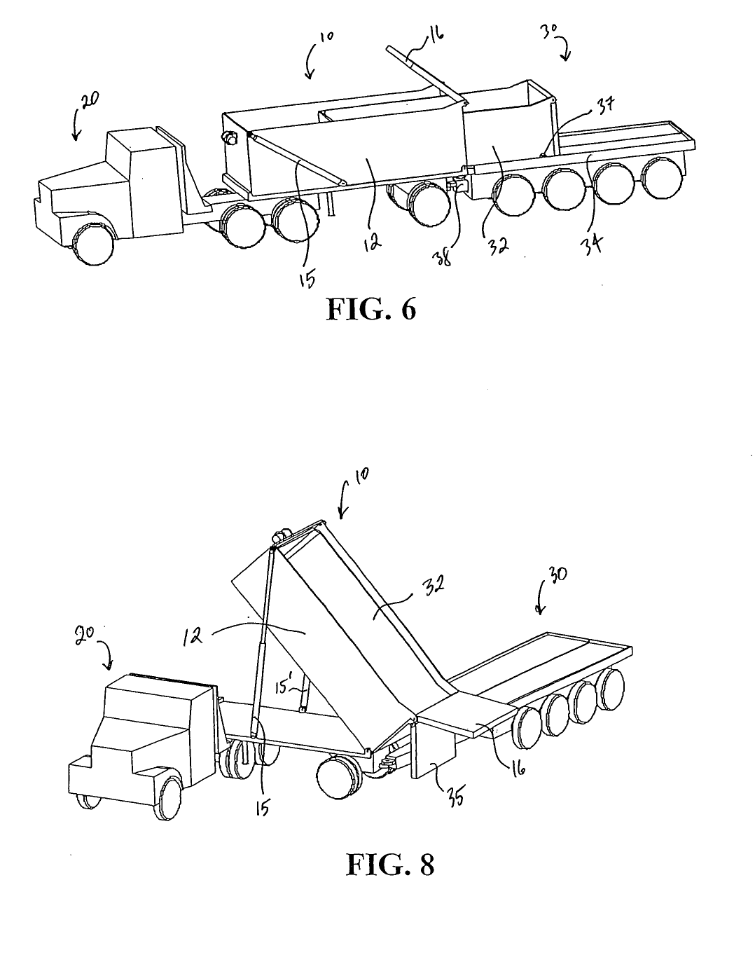

The tow trailer 30 comprises a similar construction to that of the first trailer 10, as shown in FIG. 5. However, in the preferred embodiment, the tow lacks mechanisms for dumping its load. Rather, the tow preferably leverages the dumping mechanism(s) of the first trailer to empty its contents. Preferably, the dumping body 32 of the tow 30 is mounted upon a stable frame 34 beneath which are situated a plurality of ground engaging wheels 33. This way, the dumping body 32 of the tow may be drawn into the dumping bed 12 of the first trailer 10, as illustrated in FIG. 6, and elevated to facilitate dumping of the contents of the tow trailer. The contents of the tow are preferably emptied through a gate 35 at the rear of the dumping body 32. In the preferred embodiment, mobility of the dumping body 32 is provided via a plurality of wheels 37 beneath the dumping body which allow it to roll along the supporting frame 34. The wheels may be locked or the dumping body otherwise secured above the supporting frame while the trailer set is in transit.

Preferably, the first trailer 10 and tow 30 may be drawn together via a retractable tongue 38 such that a substantially seamless connection is created between the upper surface of the supporting frame of the tow and the interior surface of the dumping bed of the trailer. This way, the dumping body 32 of the tow may be easily rolled into the dumping bed 12 of the trailer. The extendable and retractable tongue 38 of the preferred embodiment allows the gap between the trailer and tow to be readily opened prior to transport or closed prior to dumping to facilitate movement of the tow's dumping body into the bed of the first trailer. Preferably, the extension and retraction of the tongue is driven by a hydraulic cylinder or other powerful device (not shown).

In the preferred embodiment, the trailer set is jackknifed, as shown in FIGS. 7 and 8 to dump the trailer 10 and tow vehicle 30 so that loads are deposited generally to the side of the path of the tow vehicle. This way, both trailers may be dumped and no additional structure is required on the tow vehicle to facilitate movements over or around such deposits. It may be necessary to jackknife the trailer set, empty the contents of the first trailer and realign the set prior to drawing the trailer and tow together. In such situations, the trailer set is preferably again jackknifed to accommodate dumping of the tow vehicle dumping body 32 once it has been pulled into the bed 12 of the first trailer.

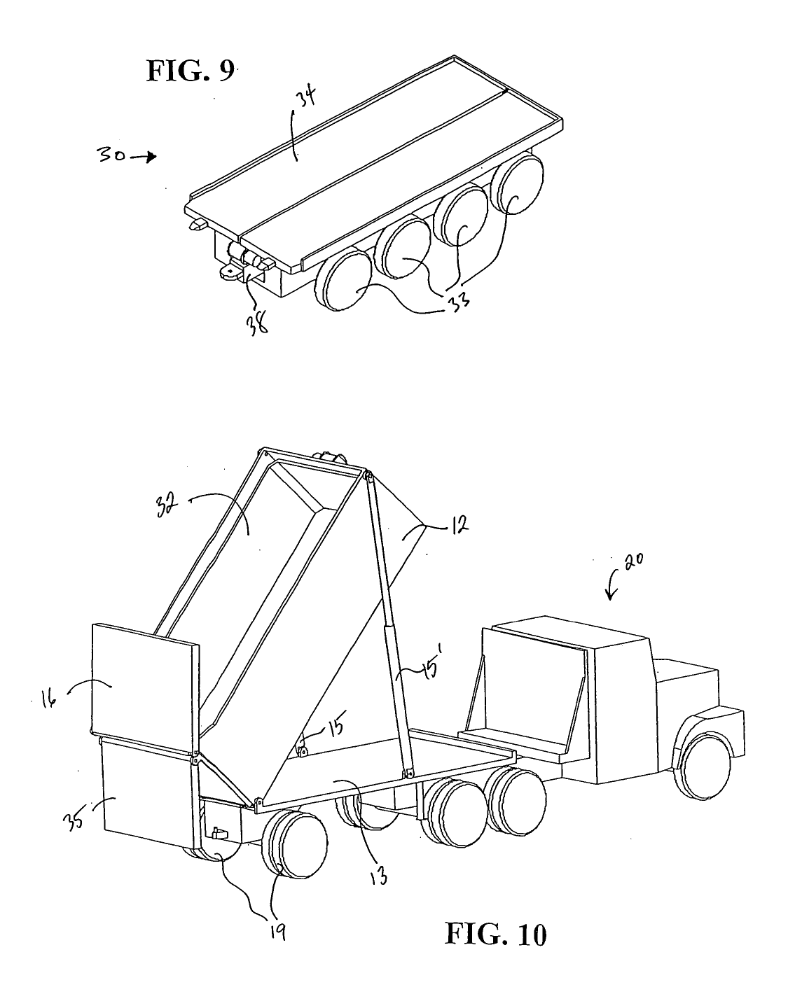

Alternatively, a less preferred method of emptying the contents of the trailer set may involve unhooking the tow vehicle 30 from the first trailer 10 prior to dumping the first trailer, as shown in FIGS. 9 and 10. After the first trailer is dumped, the tow may be reattached, drawn into the dumping bed of the first trailer and dumped. Preferably, the trailer set is jackknifed prior to emptying the dumping body of the tow vehicle so that loads are not deposited in the path of the tow vehicle. Alternatively, the tow vehicle frame 34 may be unhooked and the first trailer 10 moved to a different, dumping location not in front of the tow vehicle. Preferably, after the trailers have been dumped, the trailer set is realigned and the dumping body 32 of the tow is returned to a traveling position above the tow vehicle frame 34 and secured. However, it may be possible to transport the dumping body of the tow within the bed of the first trailer.

The versatile trailer set of the present invention offers significant advantages to drivers/owners of such tow combinations. First, the load capacity of the trailer set is easily modifiable to accommodate large or small loads by simply detaching the tow vehicle. Second, because the trailer set may be towed by any conventional truck or tractor, the trailer set allows drivers/owners to haul loads of bulk materials such as, for example, sand and gravel, without committing to the purchase of an inflexible dump truck. This flexibility allows drivers/owners to easily adjust to the changing demands of their customers. Finally, the trailer set may offer a significant financial advantage to drivers/owners. Insurance for automobiles, specifically trucks, can be very expensive whereas insuring trailers tends to be significantly less costly. As a result, employing a single truck or tractor that may be used to haul a variety of cargos may alleviate the large expense associated with insuring a separate truck for each type of load (i.e. insuring a dump truck capable of hauling only bulk materials in addition to a truck for towing various cargo trailers). Therefore, the bulk hauling trailer set of the present invention provides a substantial advantage to owners/drivers of hauling vehicles.

Although this invention has been described above with reference to particular means, materials and embodiments, it is to be understood that the invention is not limited to these disclosed particulars, but extends instead to all equivalents within the scope of the following claim.

1. A trailer and tow vehicle combination comprising:
A first dumping trailer comprising a frame with a plurality of ground engaging wheels beneath said frame and a dumping body mounted above said frame wherein the contents of said dumping body may be emptied by actuating a tilting mechanism adapted to lift the front end of the dumping body substantially above a traveling height above said frame to direct said contents out a gate at the rear of said dumping body; and
a tow vehicle comprising a frame wherein below said frame a plurality of ground engaging wheels are mounted and above said frame is mounted a dumping body on a moveable platform the dumping body and platform being adapted to be drawn into the dumping body of the first trailer by a conventional winch and tilted inside said dumping body of said first trailer to dump the contents of said dumping body through a gate positioned at the rear of said dumping body.
